(19) United States
(12) Patent Application Publication
(10) Pub. No.: US 2014/0029969 A1
(43) Pub. Date: Jan. 30, 2014

(54) PRINTING DEVICE AND CONTROL METHOD

(71) Applicant: CANON KABUSHIKI KAISHA, Tokyo (JP)

(72) Inventor: Kensuke Kawajiri, Yokohama-shi (JP)

(73) Assignee: CANON KABUSHIKI KAISHA, Tokyo (JP)

(21) Appl. No.: 13/950,001

(22) Filed: Jul. 24, 2013

(30) Foreign Application Priority Data
Jul. 26, 2012 (JP) 2012-165363

(51) Int. Cl. G03G 15/00; G03G 21/00

(52) U.S. Cl. CPC G03G 15/5004
USPC 399/75

(57) ABSTRACT

The present invention relates to a printing device comprising, a storage unit configured, before the printing device is turn off, to store information according to a state of the printing device, and a control unit configured, after the printing device is turn on, to control so that the printing device shifts to a state according to the information stored in the storage unit.

### BACKGROUND OF THE INVENTION

1. Field of the Invention

The present invention relates to a printing device and a control method.

2. Description of the Related Art

Conventionally, a printing apparatus for outputting printed data is controlled to shift to a wait state (a standby state) when electric power is supplied, the wait state being in which the printing apparatus waits for a user to press a power switch. Moreover, the printing apparatus is controlled to shift to an ON state when the user presses the power switch. In such a printing apparatus, generally, there is also a known control by which the printing apparatus is shifted to the ON state depending on whether the power switch has been pressed before power is supplied. In this case, the printing apparatus is shifted to the ON state without pressing the power switch by the user (see Japanese Patent Application Laid-Open No. 2011-160526).

However, a conventional printing device can only control whether to shift the printing apparatus to the ON state. Accordingly, the printing apparatus cannot be shifted to other states although the printing apparatus can remain in each of the other states including a sleep state in addition to the ON state.

Moreover, if the printing apparatus is in the ON state before receiving the power supply, the conventional printing device can simply control the printing apparatus to always shift to the ON state after receiving the power supply. Consequently, the printing apparatus is shifted to the ON state even when the ON state is not desired, for example, when the printing apparatus is in the ON state before receiving the power supply and has a device failure.

### SUMMARY OF THE INVENTION

The present invention is directed to a configuration in which after power supply to a printing apparatus is stopped and then resumed, a power supply state of the printing apparatus is automatically shifted to a power supply state adapting to a power supplying state before the power supply is stopped.

According to an aspect of the present invention, a printing device comprising, a storage unit configured, before the printing device is turn off, to store information according to a state of the printing device, and a control unit configured, after the printing device is turn on, to control so that the printing device shifts to a state according to the information stored in the storage unit.

Further features and aspects of the present invention will become apparent from the following description of exemplary embodiments with reference to the attached drawings.

### BRIEF DESCRIPTION OF THE DRAWINGS

FIG. 1 is a cross-sectional view illustrating a configuration of a printing apparatus.

FIG. 2 is a block diagram illustrating a control configuration of the printing apparatus illustrated in FIG. 1.

FIG. 3 is a diagram illustrating a hardware configuration of a printer illustrated in FIG. 2.

FIG. 4 is a diagram illustrating a list of possible statuses entered by the printing apparatus.

FIG. 5 is a flowchart illustrating a control method for a printing device.

FIG. 6 is a flowchart illustrating a control method for the printing device.

FIG. 7 is a flowchart illustrating a control method for a printing device.

### DESCRIPTION OF THE EMBODIMENTS

Various exemplary embodiments, features, and aspects of the invention will be described in detail below with reference to the drawings.

### System Configuration

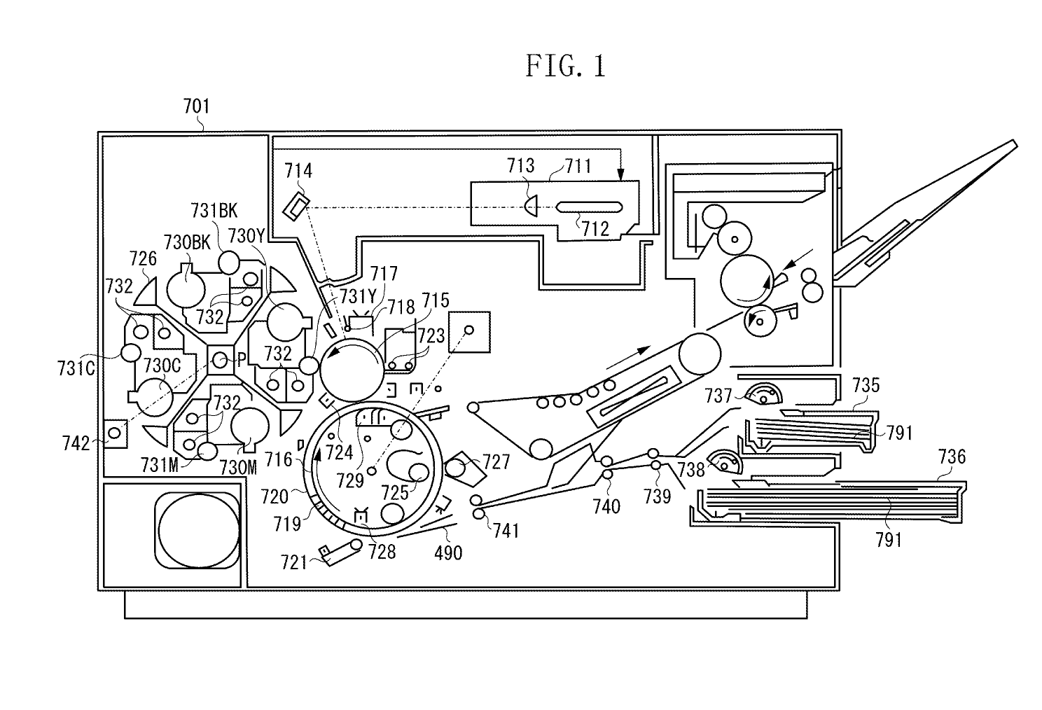

A first exemplary embodiment will be described. FIG. 1 is a cross-sectional view illustrating a configuration of a printing apparatus employing a printing device according to the first exemplary embodiment of the present invention. In FIG. 1, a scanner 711 includes a laser output unit (not illustrated) for converting an image signal into an optical signal, a polygonal mirror 712, a motor (not illustrated) for rotating the polygonal mirror 712, and an f/θ lens 713. The polygonal mirror 712 is a polyhedron, for example, octahedron. The laser light emitted from the laser output unit is reflected by one surface of the polygonal mirror 712, and passes the f/θ lens 713 and a reflection mirror 714. After passing the reflection mirror 714, the laser light linearly raster-scans a surface of a photosensitive drum 715 rotating in a direction indicated by an arrow illustrated in FIG. 1.

Accordingly, an electrostatic latent image corresponding to an image on a document is formed on the surface of the photosensitive drum 715. On the periphery of the photosensitive drum 715, a primary charging device 717, a whole surface exposure lamp 718, a cleaning unit 723 for collecting a residual toner not transferred, and a pre-transfer charging device 724 are disposed. A developing unit 726 develops the electrostatic latent image formed on the surface of the photosensitive drum 715. The developing unit 726 includes the following components.

Each of development sleeves 731Y, 731M, 731C, and 731Bk are in contact with the photosensitive drum 715, and directly develops the electrostatic latent image formed on the photosensitive drum 715. Toner cartridges 730Y, 730M, 730C, and 730Bk store backup toners. Each screw 732 conveys a developer. The development sleeves 731Y, 731M, 731C, and 731Bk, the toner cartridges 730Y, 730M, 730C, and 730Bk, and the screws 732 are arranged around a center shaft P of the developing unit 726. The reference letters Y, M, C, and Bk of these components indicate colors.

That is, references letters “Y”, “M”, “C”, and “Bk” represent yellow, magenta, cyan, and black, respectively. A door 701 can be opened and closed by a user. The user can remove any of the toner cartridges 730Y, 730M, 730C, and 730Bk only positioned directly below the door 701. The position directly below the door 701 is called a replacement position.

In FIG. 1, the toner cartage 730Bk of black is in the replacement position. The toner cartridges 730Y, 730M, 730C, and 730Bk are rotated around the shaft P, so that a toner color in the replacement position can be changed. Moreover, this printing apparatus can print at the highest speed when the black toner cartage 730Bk is in the replacement position. However, a toner color in the replacement position for the highest printing speed may differ depending on an engine configuration.

A developing unit position sensor 742 detects a rotation position of the developing unit 726. When a yellow toner image is formed, the developing unit 726 performs yellow toner development processing in a position illustrated in FIG. 1. When a magenta toner image is formed, the developing unit 726 is rotated around the shaft P in FIG. 1 such that the development sleeve 731M inside a magenta developing device is in contact with the photosensitive drum 715. When cyan and black color toner images are formed, similar operations are performed.

A transfer drum 716 transfers the toner image formed on the photosensitive drum 715 to a sheet. An actuator plate 719 detects a movement position of the transfer drum 716. A position sensor 720 detects a movement of the transfer drum 716 to a home position by coming close to the actuator plate 719.

The actuator plate 719, the position sensor 720, a transfer drum cleaner 725, a sheet pressing roller 727, and a discharging device 729 serving as a transfer charging device are arranged on the periphery of the transfer drum 716. Meanwhile, sheet feeding cassettes 735 and 736 store sheets 791. In the present exemplary embodiment, for example, the sheet feeding cassette 735 stores an A4-size sheet, whereas the sheet feeding cassette 736 stores an A3-size sheet. The sheets are fed from the sheet feeding cassettes 735 and 736 by respective sheet feeding roller 737 and 738.

Timing rollers 739, 740, and 741 adjust timings of sheet feeding and sheet conveyance. A sheet is guided to a sheet guide 490 through these rollers 739, 740, and 741 and wound around the transfer drum 716 with a leading end thereof sandwiched by a gripper 728. Then, the sheet undergoes image forming processing. Such a configuration enables full-color printing to be performed with four colors of YMCK.

In FIG. 1, the printing apparatus including one transfer drum 716 is described as an example. However, a configuration of the printing apparatus is not limited thereto. The printing apparatus may have the transfer drum 716 for the respective colors of Y, M, C, and Bk.

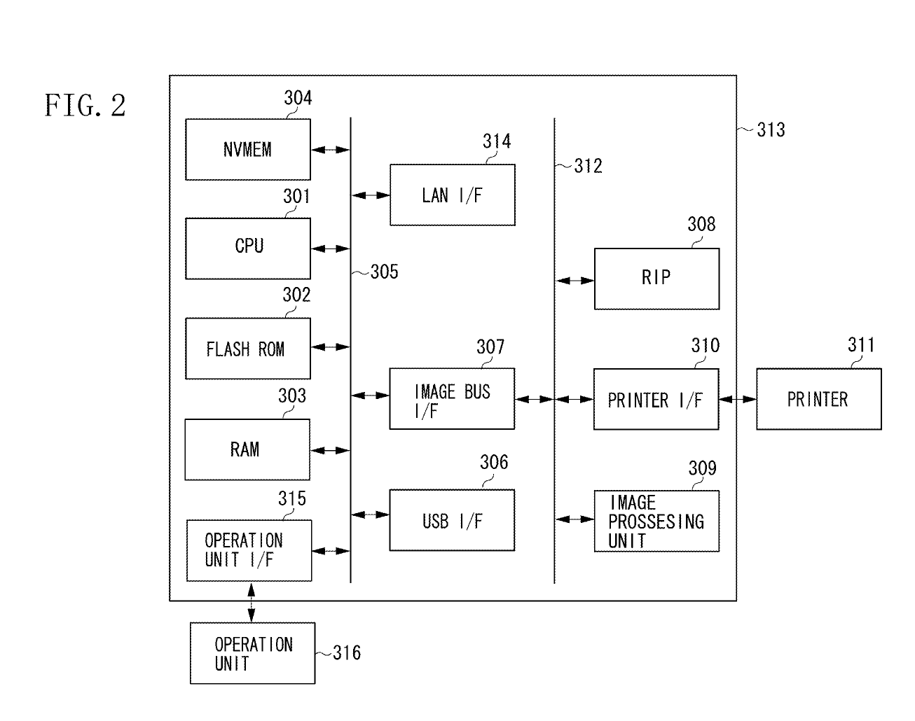

FIG. 2 is a block diagram illustrating a control configuration of the printing device illustrated in FIG. 1. Hereinafter, a configuration of a controller unit 313 for controlling a printer 311 is described in detail. In FIG. 2, the controller unit 313 inputs and outputs image data and device information by connecting to the printer 311 functioning as an image output device. A central processing unit (CPU) 301 is a processor for controlling the entire system.

A random access memory (RAM) 303 serves as a system work memory for operation of the CPU 301. Moreover, the RAM 303 serves as a program memory for storing a program, and an image memory for temporality storing image data. A non-volatile memory (NVMEM) 304 stores setting information and the like. An operation unit 316 includes keys used to operate the device, and a light emitting diode (LED) indicating a state of the device. An operation unit interface (I/F) 315 interfaces with the operation unit 316, and transmits control information of the LED included in the operation unit 316.

Moreover, the operation unit I/F 315 has a function of notifying the CPU 301 of the information input from the operation unit 316 by a user. A flash read only memory (FLASHROM) 302 is a rewritable non-volatile memory, and stores various control programs for controlling a system. A universal serial bus (USB) interface 306 allows a USB connection to an external device. A local area network (LAN) interface 314 allows a LAN connection to an external device. These devices are arranged on a system bus 305.

An image bus I/F 307 connects the system bus 305 and an image bus 312 for transmitting image data at high speed. The image bus I/F 307 serves as a bus bridge for converting a data structure. The image bus 312 includes a peripheral component interconnect (PCI) bus of Institute of Electrical and Electronics Engineers (IEEE) 1394. On the image bus 312, the following devices are arranged. A raster image processor (RIP) 308 rasterizes vector data such as a page description language (PDL) record into a bitmap image. A printer I/F 310 connects the printer 311 and the controller unit 313, so that synchronous/asynchronous conversion of image data is performed, a control command is transmitted and received, and electric power is supplied.

An image processing unit 309 corrects, processes, and edits input image data. The image processing unit 309 also performs correction and resolution conversion for the printer with respect to print-out image data. In addition, the image processing unit 309 rotates image data, and performs compression/decompression processing such as Joint Photographic Experts Group (JPEG) processing on multivalued image data and Joint Bi-level Image Experts Group (JBIG), Modified Modified read (MMR), and Modified Huffman (MH) processing on binary image data.

The printer 311 converts a raster image data into an image on a sheet. There is a plurality of conversion methods including an electrophotographic method using a photosensitive drum or a photosensitive belt, and an inkjet method enabling an image to be directly printed on a sheet by discharging ink from a minute nozzle array. However, the printer 311 can employ any method. A print operation is started by an instruction from the CPU 301.

The controller unit 313 retains a power supply state notification value in the NVMEM 304, and manages such a value. In the present exemplary embodiment, the power supply state notification value includes a value of a specific state, for example, a value of any of a plurality of states such as an OFF state, an ON state, and a SLEEP state. When the controller unit 313 receives an inquiry about a shifting target state from the printer 311 through printer I/F 310, the controller unit 313 responds to the inquiry from the printer 311 with a value of the power supply state notification value. The OFF state is also called a switch pressing wait state. The OFF state corresponds to a state in which the supply of power is started if a power switch is pressed.

The controller unit 313 retains a power supply state notification mode value in the NVMEM 304, and manages such a value. In the present exemplary embodiment, the power supply state notification mode value includes any of values of MODE 1, MODE 2, MODE 3 and MODE 4. The power supply state notification mode value can be optionally set by a user with the operation unit 316.

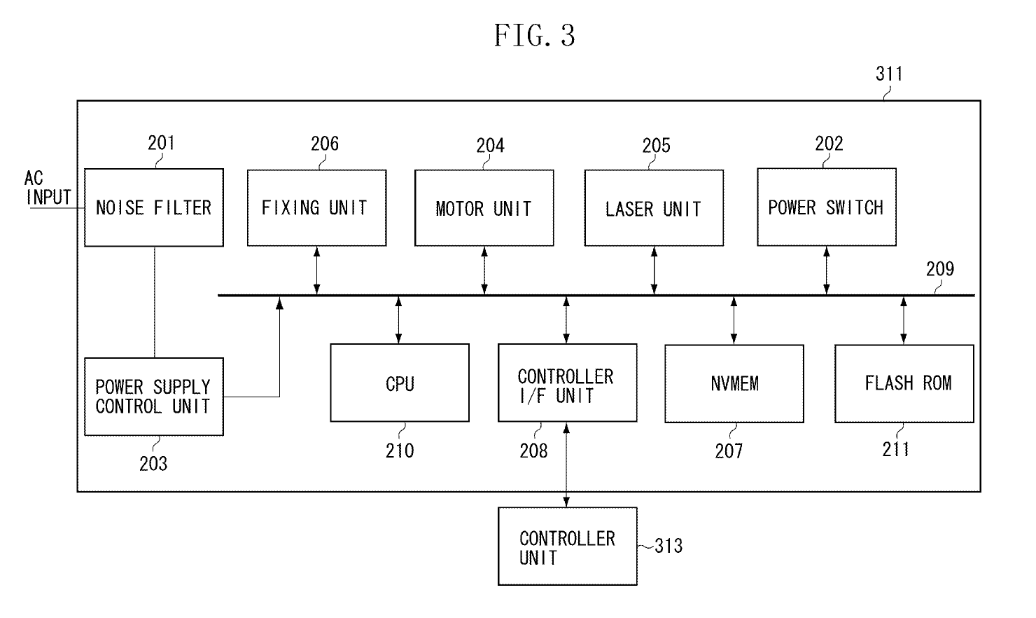

FIG. 3 is a diagram illustrating a hardware configuration of the printer 311 illustrated in FIG. 2. Hereinafter, a detailed description is given of a configuration of the printer 311 communicating with the controller unit 313. The printer 311 corresponds to an engine for performing print processing on a sheet.

In FIG. 3, the printer 311 includes a noise filter 201, a power switch 202, and a power supply control unit 203 for supplying the electric power needed for each unit to operate. The printer 311 receives power supply when the power is supplied from an AC input. A motor unit 204 rotates the sheet feeding roller 737 and 738, the primary charging device 717, the photosensitive drum 715, the developing unit 726, a fixing roller, and the sheet pressing roller 727 which perform an electrophotographic process while conveying a sheet.

A laser unit 205 controls a laser element for generating laser light used to write an image on the photosensitive drum 715. The laser unit 205 also controls ON/OFF of the laser element and an amount of the light from the laser element. A fixing unit 206 performs heat fixing by controlling a fixing heater serving as a heat source for the heat fixing.

The NVMEM 207 is a non-volatile memory, and stores setting information relating to a print setting. A FLASHROM 211 is a rewritable non-volatile memory, and stores various control programs for controlling a system.

A controller I/F unit 208 connects the printer 311 and the controller unit 313, so that synchronous/asynchronous conversion of image data is performed, a control command is transmitted and received, and electric power is supplied. The power supply control unit 203, the motor unit 204, the laser unit 205, the NVMEM 207, and the controller I/F unit 208 are connected by a system bus 209 and controlled by a CPU 210.

The printer 311 retains a power supply state value in the NVMEM 207. In the present exemplary embodiment, the power supply state value includes a value of any of an OFF state, an ON state, and a SLEEP state. In addition to these states, a deep sleep state saving more power than the SLEEP state may be added. Herein, the deep sleep state is a state in which the power supply to CPU, RAM and a hard disk drive (HDD) is stopped, whereas the power is supplied to a device needed for a network to function.

Herein, if the CPU 210 detects that the power switch 202 is pressed while a power supply state value is in the ON state, the CPU 210 changes the power supply state value to the OFF state. Such a state change is notified to the controller unit 313 through the controller I/F unit 208.

If the CPU 210 detects that the power switch 202 is pressed while a power supply state value is in the OFF state, the CPU 210 changes the power supply state value to the ON state. Such a state change is notified to the controller unit 313 through the controller I/F unit 208. Upon receipt of an instruction to change the power supply state value from the controller unit 313 through the controller I/F unit 208, the CPU 210 changes the power supply state value to the state instructed by the controller unit 313.

When detecting a change of the power supply state value, the CPU 210 controls the power supply such that the power is supplied to the power supply control unit 203 according to each state. In the ON state, the power is supplied to the CPU 210, the NVMEM 207, the FLASHROM 211, the controller I/F unit 208, the power switch 202, the fixing unit 206, the motor unit 204, the laser unit 205, and the controller unit 313.

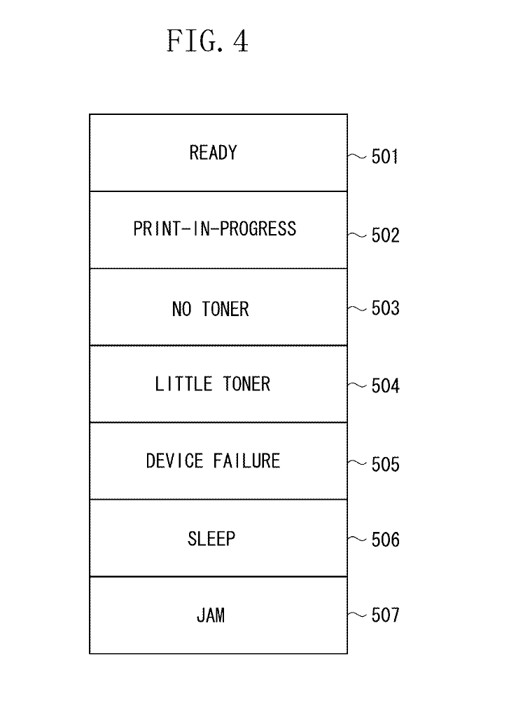

In the OFF state, the power is supplied to the CPU 210, the NVMEM 207, the FLASHROM 211, and the power switch 202. In the SLEEP state, the power is supplied to the CPU 210, the NVMEM 207, the FLASHROM 211, the controller I/F unit 208, and the power switch 202. FIG. 4 is a diagram illustrating a list of possible statuses entered by the printing apparatus according to the present exemplary embodiment. A value indicating each status is stored in the NVMEM 304. Each of the statuses is described below.

In FIG. 4, a status 501 indicates that the printer 311 is ready (on standby) for a print operation. A status 502 indicates that the print operation by the printer 311 is in progress.

A status 503 indicates that there is no toner in the printer 311. In the status 503, a toner cartridge is not set in the printer 311. A status 504 indicates little toner in which a remaining amount of the toner in the toner cartridge is little although the printer 311 can perform a print operation. A status 505 indicates that some kind of failure has occurred in the printer 311 due to a device failure, and a print operation cannot be performed.

A status 506 indicates a sleep state, that is, the printer 311 remains ready (in the status 501) for a certain time period without any change. A status 507 indicates that a sheet is jammed inside the printer 311, and a print operation cannot be performed.

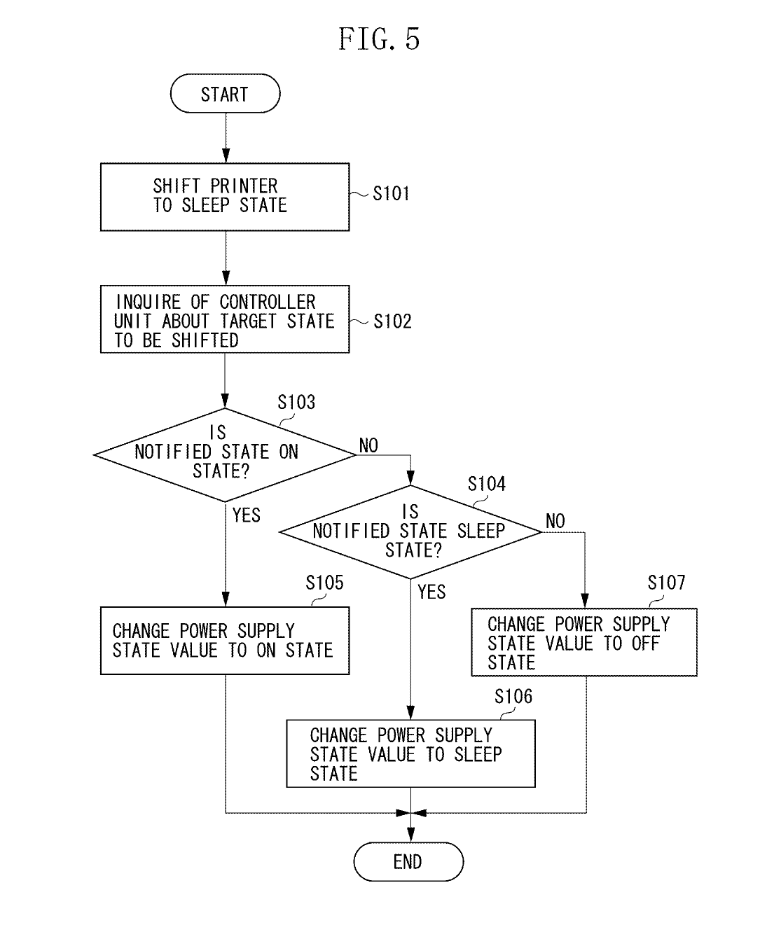

FIG. 5 is a flowchart illustrating a control method for the printing device according to the present exemplary embodiment. This flowchart illustrates an example of activation processing performed when power supply to the printer 311 is resumed. Each step in the flowchart illustrated in FIG. 5 is realized by the CPU 210 processing the program stored in the FLASHROM 211.

In step S101, when the power is supplied by the power supply control unit 203, the printer 311 is shifted to the SLEEP state. In step S102, the CPU 210 of the printer 311 inquires of the controller unit 313 through the controller I/F unit 208 about a target state to be shifted. In step S103, the printer 311 determines whether the target state to be shifted notified from the controller unit 313 is an ON state.

If the CPU 210 determines that the notified state is the ON state (YES in step S103), the operation proceeds to step S105. In step S105, the CPU 210 changes a power supply state value to the ON state, and the processing ends.

On the other hand, if the CPU 210 determines that the notified state is not the ON state (NO in step S103), then in step S104, the CPU 210 of the printer 311 determines whether the notified state is a SLEEP state. If the CPU 210 determines that the notified state is the SLEEP state (YES in step S104), the operation proceeds to step S106. In step S106, the CPU 210 changes the power supply state value to the SLEEP state, and the processing ends. On the other hand, if the CPU 210 determines that the notified state is not the SLEEP state (NO in step S104), the operation proceeds to step S107. In step S107, the CPU 210 changes the power supply state value to an OFF state, and the processing ends.

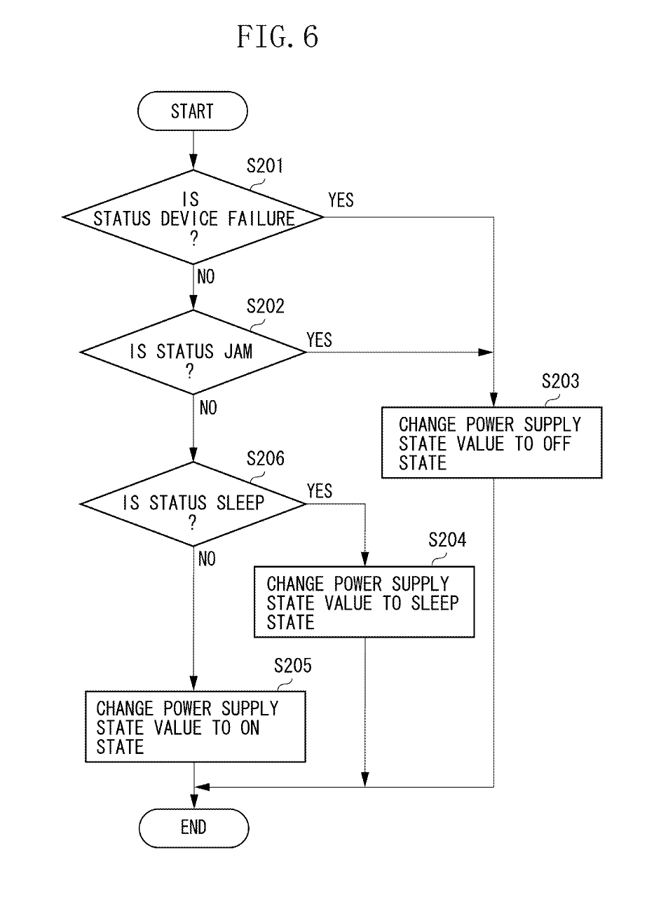

FIG. 6 is a flowchart illustrating a control method for the printing device according to the present exemplary embodiment. This flowchart illustrates an example of processing for rewriting a power supply state notification value of the controller unit 313 when any of the statuses 501 through 507 possibly entered by the printer 311 is changed. Each step in the flowchart illustrated in FIG. 6 is realized by the CPU 301 inside the controller unit 313 processing the program stored in the FLASHROM 302.

In step S201, the CPU 301 determines whether a status after the change is a device failure (the status 505). If the CPU 301 determines that the changed status is the device failure (the status 505) (YES in step S201), the operation proceeds to step S203. In step S203, the CPU 301 changes the power supply state notification value to an OFF state, and the processing ends.

On the other hand, if the CPU 301 determines that the status after the change is not the device failure (the status 505) (NO in step S201), then in step S202, the CPU 301 determines whether the status after the change is a jam (the status 507). If the CPU 301 determines that the status after the change is the jam (the status 507) (YES in step S202), the operation proceeds to step S203. In step S203, the CPU 301 changes the power supply state notification value to the OFF state, and the processing ends.

On the other hand, if the CPU 301 determines that the status is not the jam (the status 507) (NO in step S202), then in step S206, the CPU 301 determines whether the status after the change is a sleep (the status 506). If the CPU 301 determines that the status is the sleep (the status 506) (YES in step S206), the operation proceeds to step S204. In step S204, the CPU 301 changes the power supply state notification value to a SLEEP state, and the processing ends.

On the other hand, if the status is not the sleep (the status 506) (NO in step S206), the operation proceeds to step S205. In step 5205, the CPU 301 changes the power supply state notification value to the ON state, and the processing ends. Accordingly, if the printer 311 is in any of the statuses of ready (the status 501), print-in-progress (the status 502), no toner (the status 503), and little toner (the status 504), the power supply state notification value is set to the ON state.

Moreover, this processing may be executed at timing when the OFF state is notified from the printer 311 through the controller I/F unit 208 instead of timing when any of the statuses 501 through 507 is changed.

A second exemplary embodiment of the present invention is described. In the first exemplary embodiment, an inquiry from the printer 311 about a target state to be shifted (step S102 of the flowchart illustrated in FIG. 5) is responded with a value of a power supply state notification value. However, a fixed value may be used as a response to the inquiry according to a mode designated by a user with the operation unit 316. In the second exemplary embodiment, such a case is described in detail.

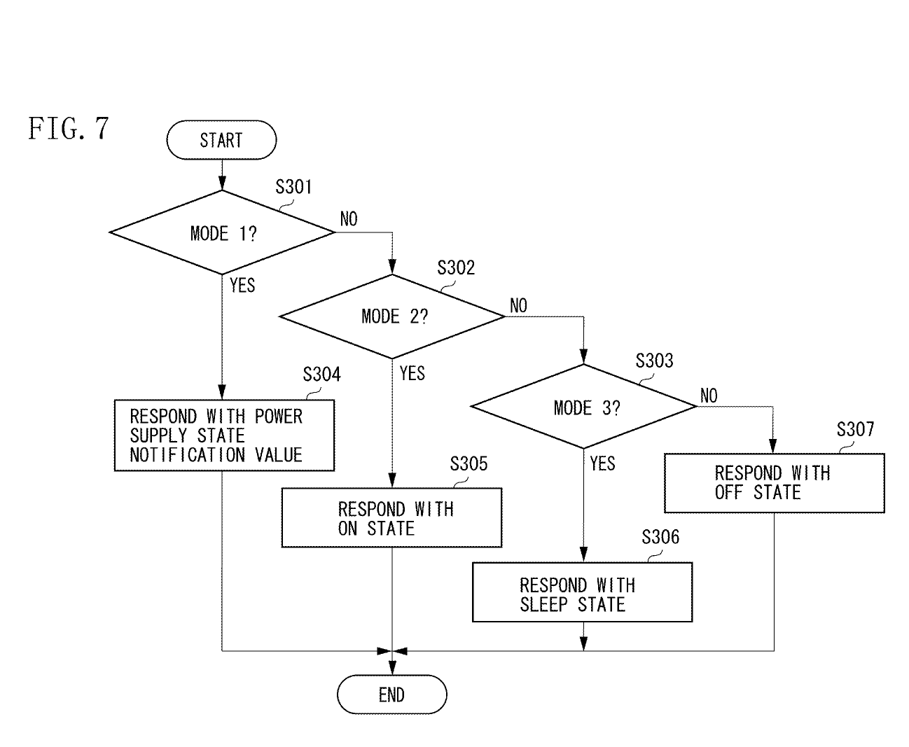

FIG. 7 is a flowchart illustrating a control method for a printing device according to the present exemplary embodiment. This flowchart illustrates an example of response processing performed by a controller unit 313 when an inquiry from a printer 311 about a target state to be shifted (step S102 of the flowchart illustrated in FIG. 5) is received. Each step in the flowchart illustrated in FIG. 7 is realized by a CPU 301 inside the controller unit 313 processing the program stored in a FLASHROM 302.

In step S301, upon receipt of the inquiry from the printer 311 about the target state to be shifted (step S102), the CPU 301 determines whether a value of a power supply state notification mode value stored in a NVMEM 304 is MODE 1. If the CPU 301 determines that the value of the power supply state notification mode value is the MODE 1 (YES in step S301), the operation proceeds to step S304. In step S304, the CPU 301 responds to the inquiry from the printer 311 with the value of the power supply state notification value, and the processing ends. On the other hand, if the CPU 301 determines that the value of the power supply state notification mode value is not the MODE 1 (NO in step S301), then in step S302, the 301 determines whether the value of the power supply state notification mode value is mode 2.

If the CPU 301 determines that the value of the power supply state notification mode value is the mode 2 (YES in step S302), the operation proceeds to step S305. In step S305, the CPU 301 responds to the inquiry from the printer 311 with an ON state, and the processing ends. On the other hand, if the CPU 301 determines that the value of the power supply state notification mode value is not the mode 2 (NO in step S302), then in step S303, the CPU 301 determines whether the value of the power supply state notification mode value is MODE 3. If the CPU 301 determines that the value of the power supply state notification mode value is the MODE 3 (YES in step S303), the operation proceeds to step S306. In step S306, the CPU 301 responds to the inquiry from the printer 311 with a SLEEP state, and the processing ends.

On the other hand, if the CPU 301 determines that the value of the power supply state notification mode value is not the MODE 3 (NO in step S303), the operation proceeds to step S307. In step S307, the CPU 301 responds to the inquiry from the printer 311 with an OFF state, and the processing ends.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-165363 filed Jul. 26, 2012, which is hereby incorporated by reference herein in its entirety.

What is claimed is:

1. A printing device comprising:
a storage unit configured, before the printing device is turn off, to store information according to a state of the printing device; and
a control unit configured, after the printing device is turn on, to control so that the printing device shifts to a state according to the information stored in the storage unit.

2. The printing device according to claim 1, further comprising a rewriting unit configured to rewrite the information stored in the storage unit in response to a change of a state of the printing device.

3. The printing device according to claim 1, wherein the information indicates any of a switch pressing wait state, an ON state, a sleep state, and a deep sleep state.

4. The printing device according to claim 1, further comprising a setting unit configured to set a plurality of modes to be notified to an engine, and
a notification unit configured to notify any one of a switch pressing wait state, an ON state, a sleep state, and a deep sleep state, according to any one of the plurality of modes.

5. The printing device according to claim 4, wherein the notification unit notifies of the power supply state in response to an inquiry from the engine.

6. The printing device according to claim 2, wherein, in a case where a state to be notified from an engine is a specific state, the rewriting unit stores a switch pressing wait state in the storage unit.

7. The printing device according to claim 1, wherein, after the power supply to an engine is resumed, and then a power supply state is shifted to a sleep state, the control unit shifts the state of the power supply to the engine to a different state, according to the information stored in the storage unit.

8. A control method comprising:
storing, before the printing device is turn off, information according to a state of the printing device; and
controlling, after the printing device is turn on, so that the printing device shifts to a state according to the information stored in the storage unit.
